(19) United States
(12) Patent Application Publication
(10) Pub. No.: US 2010/0131489 A1
(43) Pub. Date: May 27, 2010

(54) PERSONALIZED MOBILE SEARCH

(75) Inventors: Claudia V. Goldman-Shenhar, Mevasseret Zion (IL); Zvika Rubinstein, Raanana (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/276,512

(22) Filed: Nov. 24, 2008

(51) Int. Cl. G06F 17/30; G06F 7/00

(52) U.S. Cl. 707/710; 707/E17.108

(57) ABSTRACT

A method for performing Web searches from a mobile device comprises tracking the personal interactions between the user of the mobile device and initiator of a search process and his social relations, and ranking information retrieved from the World Wide Web according to its connection with said social relations.

### FIELD OF THE INVENTION

The present invention relates to the field of mobile devices. More particularly, the invention relates to the extension of the search capabilities of mobile devices that function as Web terminals.

### BACKGROUND OF THE INVENTION

Mobile devices, such as cellular phones and PDAs, have assumed additional functionalities with time, and are now used in a variety of applications. One widespread use of mobile devices relates to their function as Web terminals. However, the search capabilities available in mobile devices are extremely limited, because mobile devices have limitations that require a user-centric approach to make the search process effective for a mobile user. These limitations include the size of the display, the limited battery life and the limited time that a mobile user has to wait for responses.

Prior art solutions for mobile search include running known Web browsers like google.com from the mobile device. The information returned is not personalized nor customized to the specific user that initiated the search. All users will reach the same information for given similar queries without any regard to their specific environment, knowledge and social circle.

Prior art solutions do not take into account the personal and individual interactions between each user and his mobile device when processing a search request and when presenting its results to the user. Moreover, when operating in a mobile device environment, regular Web searches face the intrinsic limitations existing in a mobile device (which are avoided in searches performed from a PC), such as limited battery life, size of display and time to wait for responses.

There is therefore a need to personalize searches carried out on mobile devices towards the specific user, to make them more effective in time and relevance of results, focusing on the social context and the level of trust of the user and the sources of information found by the search process.

It is an object of the present invention to provide mobile devices having improved Web search capabilities, which rely on user- and device-specific information.

It is a further object of the invention to provide a method to operate search processes from a mobile device with improved performance.

Other objects and advantages of the invention will become apparent to the following description of embodiments thereof.

### SUMMARY OF THE INVENTION

In one aspect the invention relates to a method for performing Web searches from a mobile device, comprising tracking the personal interactions between the user of the mobile device and initiator of a search process and his social relations, and ranking information retrieved from the World Wide Web according to its connection with said social relations. The personal interactions between the user and his social relations can be tracked, for instance, using one or more of the frequency of calls to his contacts, SMS sent and received from his contacts, membership in social groups, connections to other people through his mobile device, and pictures stored and tagged with names of contacts.

In another aspect the invention also relates to a process for determining the social ranking of a source of information. In a further aspect the invention relates to a process for determining the level of trust of a person in some contact or source of piece of information. The method may further implement a process for determining the presence of a person in the context of contacts for further information, including who and when said person is willing to receive calls/SMS/mails when the contact is not a first level acquaintance, and how said person is willing to be contacted based on the time of day and status.

In one embodiment of the invention the process allows a user to determine the depth of a search process that takes into account the social distance from a person to the sources of the information found by the search process.

The rank of a page can be composed of the traditional ranking value due to the match between the query and the information in the page, and a social context ranking that behaves as a weight that increases or decreases the final ranking of the page. The social weight can be determined, for instance, by considering the social distance of the source of the page from the user that initiated the search, and/or by considering the possible preference of the user for a certain Web site, based on their name, geographic domain, or URL. The social weight can also be determined by considering the amount of interaction between the user and the source of information, said amount of interaction between the user and the source of information being selected, for example, from one or more of the frequency of calls over a period of time, SMS, chat, or mails. An additional way to determine the social weight is by considering the feedback entered by the user on previous search results and rankings.

The invention also encompasses a search engine for performing Web searches from a mobile device, comprising processes to track the personal interactions between the user of the mobile device and initiator of a search process and his social relations, and ranking information retrieved from the World Wide Web according to its connection with said social relations.

In another aspect the invention is directed to a system for performing Web searches comprising:
a) a mobile device;
b) software adapted to track the personal interactions between the user of the mobile device and initiator of a search process and his social relations; and
c) software adapted to rank information retrieved from the World Wide Web according to its connection with said social relations.

The software adapted to track personal interactions between the user and his social relations can use one or more of the frequency of calls to his contacts, SMS sent and received from his contacts, membership in social groups, connections to other people through his mobile device, and pictures stored and tagged with names of contacts. Typically, the system further comprises means for determining the social ranking of a source of information and means for determining the level of trust of a person in some contact or source of piece of information.

In a typical embodiment the system comprises a database containing personal information, including who and when a person is willing to receive calls/SMS/mails when the contact is not a first level acquaintance, and how said person is willing to be contacted based on the time of day and status, as well as a search engine for performing Web searches from a mobile device, said search engine comprising processes to track the personal interactions between the user of the mobile device and initiator of a search process and his social relations, and ranking information retrieved from the World Wide Web according to its connection with said social relations.

### BRIEF DESCRIPTION OF THE DRAWINGS

In the drawings:

FIG. 1 (a through c) is an example of a search carried out from a mobile device, which enables the user to contact the source of the relevant information directly; and

FIG. 2 illustrates the level of connectivity and the level of trust of the sources of the information found by the search process.

### DETAILED DESCRIPTION OF THE INVENTION

In order to better appreciate the advantages of the invention it is useful to briefly review some prior art methods. For instance, US2008/0005068 describes a system in which results from a search processed can be reorganized based on the user context. However, no dynamic or personal interaction between a user and his mobile device is exploited.

US 2007/0288468 relates to a method and system to use an electronic commerce system. Recommendations may be obtained from multitude of other users although the relations between these users and the initiator of the search, level of trust or social interaction are not taken into account. Also the dynamics of the interaction from a mobile device are not taken into account.

U.S. Pat. No. 7,257,577 presents a modular scoring system that allows to aggregate rank heuristics methods to a single value to rank results. These functions' domains are the information residing in the documents. No interaction of the user with the sources of information is used as a parameter that can also rank the information based on the social context of the user.

In addition to the limitations of searching with mobile devices described above other considerations specific to the mobile industry apply, inasmuch as a mobile device is carried continuously by its user. Thus, a mobile device is a useful source of additional data about the user, which can be used by a personalized mobile search engine to target its results to its specific user. Therefore, it is possible to improve the user personal experience of searching for information from a mobile device, by decomposing it into three aspects of the interaction:
1. How to include the interaction between the user and his social context in the ranking of information found by the search process?
2. How can the user contact a source of information?
3. How can the user control a threshold cutoff that will determine how much depth of search will be allowed vs. how much trustful is the information source found by the search process?

As said, prior art solutions lack elements required to make the Web search from a mobile device more efficient, and among others the following is needed:
A process to track the personal interactions between the user of the mobile device and initiator of a search process and his social relations (frequency of calls to his contacts, SMS sent and received from his contacts, membership to social groups, connections to other people through his mobile device, pictures stored and tagged with names of contacts, etc).
A process to determine the social ranking of a source of information.
A process to determine the level of trust of a person in some contact or source of piece of information.
A process to determine the presence of a person in the context of contacts for further information: who and when are you willing to get calls/SMS/mails when the contact is not a first level acquaintance? How are you willing to be contacted, based on the time of day and status?
A process to allow a user to determine the depth of a search process that takes into account the social distance from a person to the sources of the information found by the search process.

Thus according to the invention there is provided a personalized mobile search, which is the process of searching the Web extended to a mobile setting, taking advantage of the personal interaction between the user and his mobile device.

According to the invention the user initiates a search process by providing an input query. The search takes place in the Web (as in the traditional way) but it starts from the social networks where the user is a member.

The search proceeds looking for information relevant to the user query moving from pages that are trusted to pages that are outside the social context of the user, eventually, reaching the global Web where the sources of the information are not known (their URL is known but not who wrote the page).

Interacting with a mobile device that a user carries on continuously enriches the search experience in three aspects:
1. Allowing for additional social context ranking of the information found by a search engine.
2. Allowing for direct connectivity with the source of the information
3. Allowing for determining the depth of the search taking into account the trust level of the sources of the information.

Although methods for computing a reputation value are known in the art and therefore are not discussed herein in detail for the sake of brevity, never before the present invention was the issue of generating a social ranking based on personal context addressed in the literature. Skilled persons will appreciate that various schemes can be used for such purposes and that the selection of a specific procedure to the invention will not exceed the scope of the present invention.

Social Context Ranking

In one embodiment of the invention the rank of a page is composed of the traditional ranking value due to the match between the query and the information in the page and a social context ranking that behaves as a weight that increases or decreases the final ranking of the page. This social weight is determined by considering:
The social distance of the source of the page from the user that initiated the search is a measure given by the closeness of the source to the initiator in his contacts list, groups or level of acquaintance (family, colleague, friend in a small group or friend in a large group). This measure can be given by the number of edges that need to be traversed to get from the user to the source of information following contacts, or friends, or colleagues. This distance can be made shorter for example if the source also appears in the speed dial of the user.
The possible preference of the user for a certain Web site (based on their name, geographic domain, or URL)
The amount of interaction between the user and the source of information (frequency of calls over a period of time, SMS, chat, mails, etc).
Possible feedback entered by the user on previous search results and rankings.

Pages with high social ranks are presented first, allowing the user to see trustful sources of information that have higher probabilities of being chosen.

Direct Connectivity

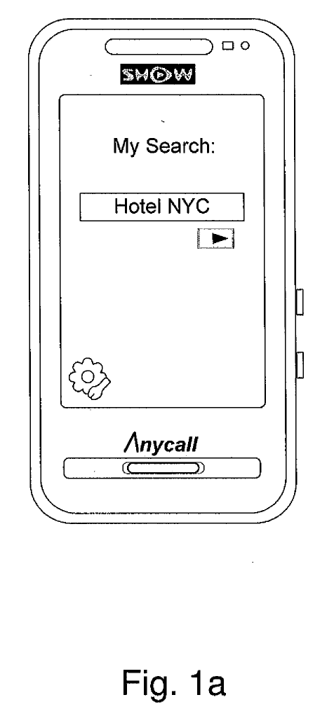

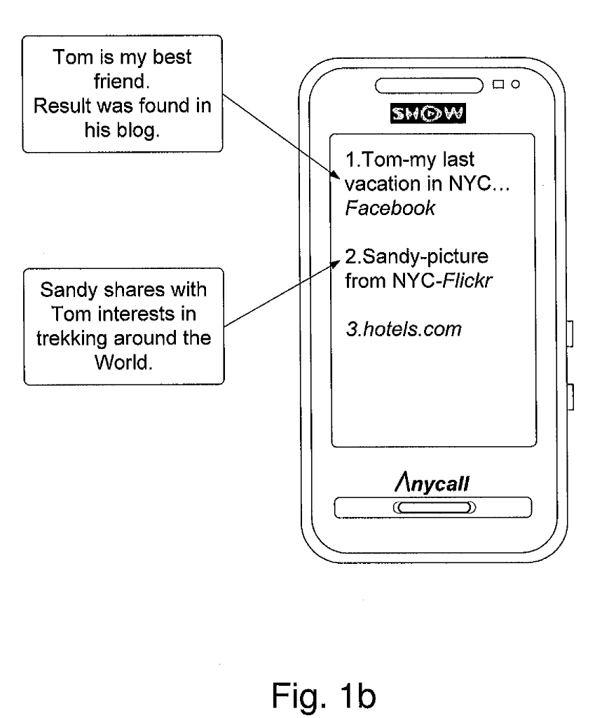

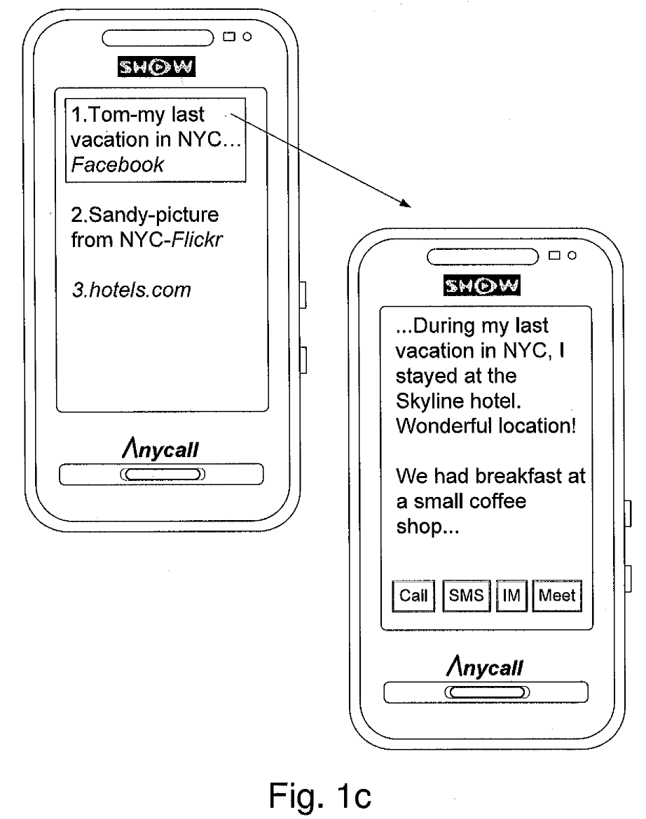

Performing the search from a mobile device enables the user to contact the source of the relevant information directly if possible. This is illustrated, for example, in FIG. 1. In example given in the figure the user needs a hotel in New York City (FIG. 1(a)). His search takes him to Tom, his best friend's blog. Sandy shares with Tom interests in trekking around the world (FIG. 1(b)). In this search the user allowed the system to reach the World Wide Web and to return at least three answers. Tom has configured his system such that he is willing to receive a call or an SMS from the user, but he is not in the user's geographic area and is not able to come and meet him. On the other hand, Sandy is available and because of her relations with Tom she is a trusted source of information. Accordingly, the user will contact Sandy (FIG. 1(c)).

Depth of Search vs. Trust Level

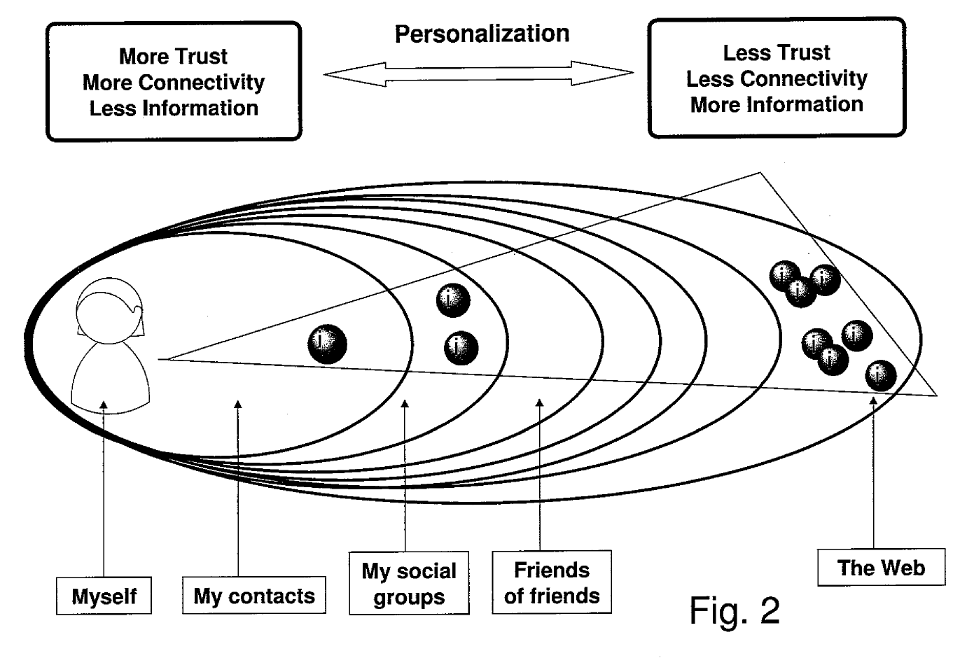

By determining the threshold cutoff, the user can control the level of connectivity and the level of trust of the sources of the information found by the search process. This is illustrated in FIG. 2. As can be seen from the figure:
1. As long as the search continues further, the probability of being able to contact the source of the information decreases.
2. Trust vs. Recall: As long as the probability of finding some result is higher, the level of trust of the source decreases. This is because the amount of information residing at the user's social circles is smaller than the total amount of information that resides on the Web.

### EXAMPLE

Tom lives in San Francisco. He is willing to buy a used car. He fills-in a query in his mobile search engine with some parameters about the car he wants. The search process starts to look at pages that anyone of his contacts has written and tries to match the text in the pages to the words in the query. It found that Bob who is Tom's friend and appears in Tom's address book has recently written in his blog about his used car that he bought from an agency in Boston. Bob wrote about the service he received at that agency and about the car he got.

The search proceeded in pages of other contacts and their blogs, pictures and other public information Tom's friends have published. The next relevant page found was written by Mary who is a peer of Bob and was Bob's former boss. Mary is currently living in San Francisco and has bought a used car a few months ago. She has included a link to her car dealer in her blog. Tom needs a car urgently because he is planning a coast-to-coast trip and his vacation is about to start in a few weeks. Tom is a very busy marketing salesman so he uses his phone constantly and he is on the move most of the day. He arrives at his home only late at night. He would like to talk with some trusted party about possibilities of buying a used car and when he gets home it is already too late to contact anybody. On the other hand, Tom is willing to get as many results as he can but he also uses the phone very much. Between seeing customers, he likes to listen to music on his mobile phone so he is limited by his battery. He has restricted his search engine to stop searching after it collects 5 results. Some of Mary's friends are members in a group of car collectors. There is some relevant information there as well. Finally the search process encounters the site cars.com that gives general information about cars for sale.

The personalized mobile search engine scores each page found by its textual relevancy to Tom's query. It also computes the social context weight of each source: Bob gets the highest weight because he is a direct friend of Tom, Mary is at distance 2 of Tom, and Mary's friends are further away but still have some social context in common with Tom that the site cars.com does not have. Bob is a very good friend of Tom so he allows his mobile phone to tell Tom that he can be contacted directly if found as a source of some relevant information. The personalized mobile search also gets presence information about Bob and since he is available on his phone, Tom gets the option to send him an SMS instead of mail or meet (Bob is in Boston and Tom is in San Francisco). Mary is on Bob's speed dial and trusts Bob very much. She has set her phone to allow the direct connect to Bob's best friends. So Tom gets also the opportunity to ask Mary to meet him to talk if he wants to discuss details about the car purchase. Mary's friends are further away so they do not have any contact information when their results are presented on the display. The same is valid for a Web site.

All the above description and examples have been provided for the purpose of illustration and are not meant to limit the invention in any way. Many variations can be made and additional processes and methods applied it together with the invention, without exceeding its scope.

1. A method for performing Web searches from a mobile device, comprising tracking the personal interactions between the user of the mobile device and initiator of a search process and his social relations, and ranking information retrieved from the World Wide Web according to its connection with said social relations.

2. A method according to claim 1, wherein the personal interactions between the user and his social relations are tracked using one or more of the frequency of calls to his contacts, SMS sent and received from his contacts, membership in social groups, connections to other people through his mobile device, and pictures stored and tagged with names of contacts.

3. A method according to claim 1, further comprising a process to determine the social ranking of a source of information.

4. A method according to claim 1, further comprising a process to determine the level of trust of a person in some contact or source of piece of information.

5. A method according to claim 1, further comprising a process to determine the presence of a person in the context of contacts for further information, including who and when said person is willing to receive calls/SMS/mails when the contact is not a first level acquaintance, and how said person is willing to be contacted based on the time of day and status.

6. A method according to claim 1, further comprising a process to allow a user to determine the depth of a search process that takes into account the social distance from a person to the sources of the information found by the search process.

7. A method according to claim 1, wherein the rank of a page is composed of the traditional ranking value due to the match between the query and the information in the page and a social context ranking that behaves as a weight that increases or decreases the final ranking of the page.

8. A method according to claim 7, wherein the social weight is determined by considering the social distance of the source of the page from the user that initiated the search.

9. A method according to claim 7, wherein the social weight is determined by considering the possible preference of the user for a certain Web site, based on their name, geographic domain, or URL.

10. A method according to claim 7, wherein the social weight is determined by considering the amount of interaction between the user and the source of information.

11. A method according to claim 10, wherein the amount of interaction between the user and the source of information is selected from one or more of the frequency of calls over a period of time, SMS, chat, or mails.

12. A method according to claim 7, wherein the social weight is determined by considering the feedback entered by the user on previous search results and rankings.

13. A search engine for performing Web searches from a mobile device, comprising processes to track the personal interactions between the user of the mobile device and initiator of a search process and his social relations, and ranking information retrieved from the World Wide Web according to its connection with said social relations.

14. A system for performing Web searches comprising:
a) a mobile device;
b) software adapted to track the personal interactions between the user of the mobile device and initiator of a search process and his social relations; and
c) software adapted to rank information retrieved from the World Wide Web according to its connection with said social relations.

15. A system according to claim 14, wherein the software adapted to track personal interactions between the user and his social relations uses one or more of the frequency of calls to his contacts, SMS sent and received from his contacts, membership in social groups, connections to other people through his mobile device, and pictures stored and tagged with names of contacts.

16. A system according to claim 14, further comprising means to determine the social ranking of a source of information.

17. A system according to claim 14, further comprising means to determine the level of trust of a person in some contact or source of piece of information.

18. A system according to claim 14, further comprising a database containing personal information, including who and when a person is willing to receive calls/SMS/mails when the contact is not a first level acquaintance, and how said person is willing to be contacted based on the time of day and status.

19. A system according to claim 14, further comprising a search engine for performing Web searches from a mobile device, said search engine comprising processes to track the personal interactions between the user of the mobile device and initiator of a search process and his social relations, and ranking information retrieved from the World Wide Web according to its connection with said social relations.
